(19) United States
(12) Patent Application Publication
(10) Pub. No.: US 2012/0038654 A1
(43) Pub. Date: Feb. 16, 2012

(54) COMPUTER SYSTEM AND RELATED GRAPHICS APPARATUS, DISPLAY APPARATUS, AND COMPUTER PROGRAM PRODUCT

(76) Inventors: Hao WANG, Shang-Hai City (CN); Xiu-Chao Sun, Shang-Hai City (CN)

(21) Appl. No.: 13/209,012

(22) Filed: Aug. 12, 2011

(30) Foreign Application Priority Data
Aug. 16, 2010 (CN) 201010257505.8

(51) Int. Cl. G06T 15/00

(52) U.S. Cl. 345/522

(57) ABSTRACT

A graphics apparatus is disclosed including: an input interface for receiving graphics commands from a computer host when detachably coupled with the computer host; an image processing circuit coupled with the input interface for generating image frames comprising graphics user interface, computer-generated icons, or texts according to the graphics commands; and an output module for transmitting the image frames to a display apparatus for display; wherein the input interface receives the graphics commands from the computer host at a frequency less than a refresh rate of the display apparatus, or the data amount of graphics commands received by the input interface from the computer host is less than the data amount of image frames transmitted to the display apparatus from the output module.

### CROSS-REFERENCE TO RELATED APPLICATIONS

This application claims the benefit of priority to Chinese Patent Application No. 201010257505.8, filed on Aug. 16, 2010, the entirety of which is incorporated herein by reference for all purpose.

### BACKGROUND

The present disclosure generally relates to image rendering technology for computer systems, and more particularly, to computer systems capable of lowering the bandwidth requirement between a computer host and a graphics apparatus, and related graphics apparatus and display apparatus.

The conventional computer system bears only one monitor. However, it has become more frequently for a user to use two or more monitors to cooperate with a computer host. The graphics card for a traditional computer host has only one or two image signal output ports and thus can be connected to up to two monitors. One way to increase the number of monitors can be simultaneously supported by a single computer host is to install more graphics cards inside the computer host. This approach, however, is apparently not economic because that the graphics card is costly and the available space for installing additional graphics cards inside the casing of the computer host is limited, and thus lacks of feasibility.

USB adapters were then developed to meet the market demand. The conventional USB adapter requires the CPU of the computer host to process all images to be displayed in the display and transmit resulting image frames to the USB adapter via a USB interface. The USB adapter then transmits the images frames to a connected monitor for display. The conventional USB adapter is merely a medium for transmitting the image frames to the monitor. As a result, the computer system is allowed to connect with more monitors via the USB interface and the USB adapter.

In related art, the frequency of transmitting the image frames from the computer host to the USB adapter and the frequency of transmitting the image frames from the USB adapter to the monitor are both required to be identical to the refresh rate of the monitor. That is, if the refresh rate of the monitor is 60 Hz, then both the frequency of transmitting the image frames from the computer host to the USB adapter and the frequency of transmitting the image frames from the USB adapter to the monitor should be 60 times per second. As a result, the computer host is required to frequently transmit huge amount of image frames to the monitor via the USB adapter. This not only consumes considerable computing resource of the CPU of the computer host, but also occupies huge bandwidth of the USB interface.

However, the total bandwidth of the USB interface of the computer host is limited. Accordingly, the use of conventional USB adapter requires the CPU to have higher computing capability, but still not able to allow a single computer host to simultaneously support much more monitors.

### SUMMARY

In view of the foregoing, it can be appreciated that a substantial need exists for solutions to increase the number of monitors can be simultaneously supported by a single computer host and extend the utilization flexibility of the computer host without installing additional graphics cards in the computer host.

An exemplary embodiment of a computer system is disclosed comprising: a computer host comprising: a processor module; and a host-end output interface coupled with the processor module for outputting graphics commands generated by the processor module; at least six display apparatuses; and at least six graphics apparatuses respectively coupled with the display apparatuses, and each of the graphics apparatuses comprising: an input interface for receiving corresponding graphics commands when detachably coupled with the host-end output interface; an image processing circuit coupled with the input interface for generating image frames comprising graphics user interface, computer-generated icons, or texts according to the graphics commands received by the input interface; and an output module coupled with one of the display apparatuses for transmitting the image frames to a coupled display apparatus for display, wherein the data amount or transmission frequency of image frames transmitted from the output module to the display apparatus is greater than the data amount or transmission frequency of graphics commands transmitted from the host-end output interface to the input interface.

An exemplary embodiment of a graphics apparatus is disclosed comprising: an input interface for receiving graphics commands from a computer host when detachably coupled with the computer host; an image processing circuit coupled with the input interface for generating image frames comprising graphics user interface, computer-generated icons, or texts according to the graphics commands; and an output module for transmitting the image frames to a display apparatus for display; wherein the input interface receives the graphics commands from the computer host at a frequency less than a refresh rate of the display apparatus, or the data amount of graphics commands received by the input interface from the computer host is less than the data amount of image frames transmitted to the display apparatus from the output module.

An exemplary embodiment of a display apparatus is disclosed comprising: an input interface for receiving graphics commands or bitmaps generated from a computer host when detachably coupled with the computer host; an image processing circuit coupled with the input interface for generating image frames comprising graphics user interface, computer-generated icons; or texts according to the graphics commands; and a display module coupled with the image processing circuit for displaying the image frames; wherein the input interface receives the graphics commands from the computer host at a frequency less than a refresh rate of the display module, or the data amount of graphics commands received by the input interface from the computer host is less than the data amount of image frames transmitted to the display module from the image processing circuit.

An exemplary embodiment of a computer program product is disclosed. The computer program product is capable of enabling a computer system to perform an image rendering operation, and the image rendering operation comprises: driving a graphics apparatus; converting a rendering request generated by an operating system of a computer host into graphics commands; transmitting the graphics commands to the graphics apparatus; wherein the graphics commands are transmitted to the graphics apparatus at a frequency less than a refresh rate of a display apparatus coupled with the graphics apparatus, or the data amount of graphics commands is less than the data amount required for refreshing the display apparatus.

An exemplary embodiment of a computer program product is disclosed. The computer program product is capable of enabling a graphics apparatus to perform an image data processing operation, and the image data processing operation comprises: receiving graphics commands generated by a computer host; generating image frames comprising graphics user interface, computer-generated icons, or texts according to the graphics commands; transmitting the image frames to a display apparatus; wherein the graphics commands are received from the computer host at a frequency less than a refresh rate of the display apparatus, or the data amount of graphics commands received from the computer host is less than the data amount of image frames transmitted to the display apparatus.

It is to be understood that both the foregoing general description and the following detailed description are exemplary and explanatory only and are not restrictive of the invention, as claimed.

### BRIEF DESCRIPTION OF THE DRAWINGS

FIG. 1 is a simplified block diagram of a computer system in accordance with an exemplary embodiment.

FIG. 2 is a partial simplified block diagram of the computer system of FIG. 1

FIG. 3 is a flowchart illustrating a method for generating images according to an exemplary embodiment.

FIG. 4 is a partial simplified block diagram of a computer system in accordance with another exemplary embodiment.

### DETAILED DESCRIPTION

Reference will now be made in detail to embodiments of the invention, which are illustrated in the accompanying drawings. The same reference numbers may be used throughout the drawings to refer to the same or like parts or components/operations.

Certain terms are used throughout the description and following claims to refer to particular components. As one skilled in the art will appreciate, vendors may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . .” Also, the phrase “coupled with” is intended to compass any indirect or direct connection. Accordingly, if this document mentioned that a first device is coupled with a second device, it means that the first device may be directly connected to the second device (including through an electrical connection or other signal connections, such as wireless communications or optical communications), or indirectly connected to the second device through an indirect electrical connection or signal connection via other intermediate device or connection means.

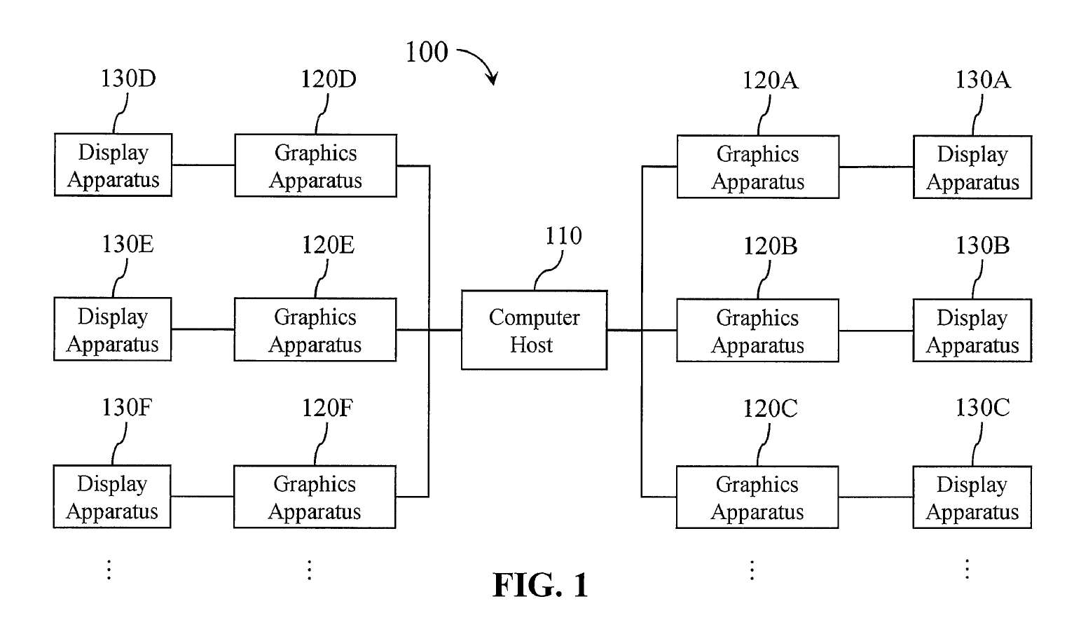

Please refer to FIG. 1, which shows a simplified block diagram of a computer system 100 in accordance with an exemplary embodiment. The computer system 100 comprises a single computer host 110, a plurality of graphics apparatuses detachably coupled with the computer host 110, and a plurality of display apparatuses respectively coupled with the graphics apparatuses. For the sake of brevity, only graphics apparatus 120A-120F and display apparatus 130A-130F are shown in FIG. 1 as examples. As shown, each graphics apparatus is coupled with the computer host 110 and one of the display apparatuses. In implementations, each display apparatus may be (but not limited to) a CRT display, a LCD display, a LED display, a plasma display, a projector, or any other displaying device.

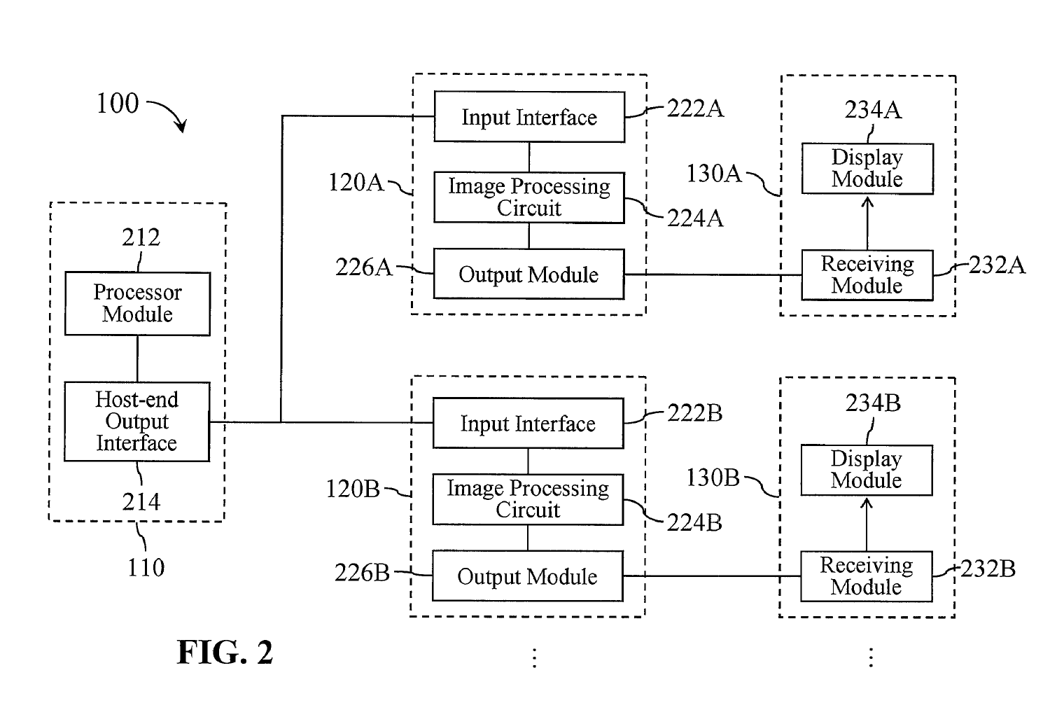

FIG. 2 shows a partial simplified block diagram of the computer system 100. In this embodiment, the computer host 110 comprises a processor module 212 and a host-end output interface 214. The processor module 212 may be the combination of one or more CPUs of the computer host 110, the combination of CPU and built-in graphics chip of the computer host 110, or the combination of CPU and the graphics chip on the graphics card installed in the computer host 110.

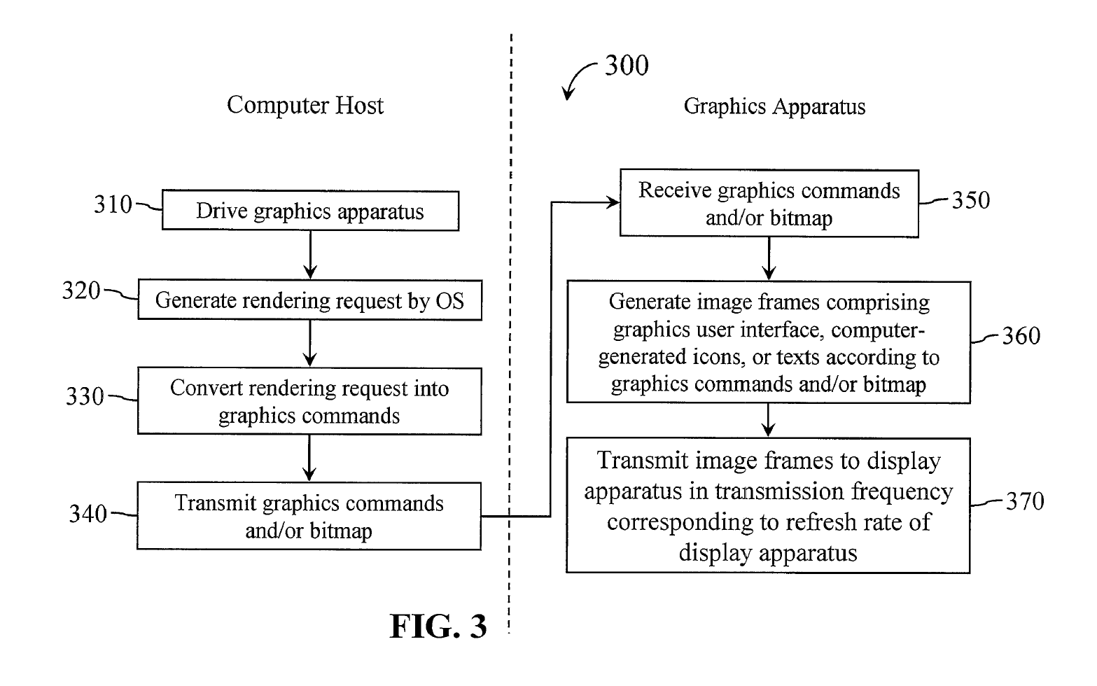

As shown in FIG. 2, each of the graphics apparatuses 120A and 120B comprises an input interface (e.g., 222A or 222B), an image processing circuit (e.g., 224A or 224B), and an output module (e.g., 226A or 226B). The input interfaces 222A and 222B of the graphics apparatuses 120A and 120B are detachably coupled with the host-end output interface 214 of the computer host 110. In addition, each of the display apparatuses 130A and 130B comprises a receiving module (e.g., 232A or 232B) and a coupled display module (e.g., 234A or 234B). In the computer system 100, the functional blocks and connection manner of the other graphics apparatuses are similar to the graphics apparatus 120A and 120B, and the functional blocks and connection manner of the other display apparatuses are similar to the display apparatuses 130A and 130B. Thus, similar details will not be repeated herein for brevity. In the following, the operations of the computer system 100 will be described further with reference to FIG. 3.

FIG. 3 shows a flowchart 300 illustrating a method for generating images according to an exemplary embodiment. The left half of the flowchart 300 illustrates the operations of the computer 110 and the right half of the flowchart 300 illustrates the operations of the graphics apparatus. The operations of the flowchart 300 also represent an embodiment of computer program processes for generating images. The flowchart 300 will be described below by taking the interaction between the computer host 110 and the graphics apparatus 120A as an example.

In operation 310, the processor module 212 of the computer host 110 executes related driver program to drive the graphics apparatus 120A. In practical application, the processor module 212 of the computer host 110 may automatically perform the operation 310 when a user couples the input interface 222A of the graphics apparatus 120A with the host-end output interface 214.

In operation 320, the operating system of the computer host 110 generates rendering requests related to text, computer-generated icons, or graphics user interface in response to a user's actions (such as typing characters or switching windows) or in response to an application program's execution results (such as generating a pup-up dialog or selection items). When the operating system of the computer host 110 issues the above rendering requests, the processor module 212 will not generate corresponding image frames based on the rendering requests, so the host-end output interface 214 needs not to transmit image frames to the graphics apparatus 120A.

Instead, the driver program of the graphics apparatus 120A executed by the processor module 212 performs operation 330 to convert the rendering requests generated by the operating system into graphics commands corresponding to the type of the operating system of the computer host 110, such as GDI commands, QuickDraw commands, GDK commands, Xlib commands, or the like. For example, assuming that the operating system of the computer host 110 is Microsoft's Windows XP, when the operating system of the computer host 110 wants to display a computer-generated icon and shortcut name of an application program on the desktop of the display apparatus 130A and therefore generates corresponding rendering requests in the operation 320, the driver program of the graphics apparatus 120A executed by the processor module 212 would perform the operation 330 to convert the rendering requests into two graphics commands, HostBLT and DrawText.

Afterward the driver program of the graphics apparatus 120A executed by the processor module 212 performs operation 340 to transmit the graphics command HostBLT and a graphic bitmap (or pixmap) corresponding to the computer-generated icon to the graphics apparatus 120A via the host-end output interface 214, and then transmits the graphics command DrawText and a font bitmap corresponding to the shortcut name to the graphics apparatus 120A via the host-end output interface 214. Please note that the computer host 110 only transmits the graphics commands and graphic bitmap and font bitmap for constituting part of the image frame to the graphics apparatus 120A, but transmit the entire image frame to the graphics apparatus 120A. As a result, the data amount to be transmitted and required computing resource of the processor module 212 can be greatly reduced.

Data transmission between the host-end output interface 214 and the input interface 222A may be conducted through various physical communication manner, such as Universal Serial Bus (USB) interface, IEEE 1394 communication interface, PC Card interface, Serial/Parallel Advanced Technology Attachment (SATA/PATA) interface, Peripheral Component Interconnect (PCI) interface, PCI Express interface, or Ethernet interface, or may be conducted through various wireless communication approach, such as IEEE 802.11 series interface, mobile communication network, or any other wireless transmission protocol. In one embodiment where the data transmission between the host-end output interface 214 and the input interface 222A is conducted through wireless communication approach, the input interface 222A comprises a wireless receiver for receiving the graphics commands generated by the computer host 110 using wireless transmission manner. No manner which communication protocol is employed for the data transmission between the host-end output interface 214 and the input interface 222A, the total data transmission bandwidth of the host-end output interface 214 is finite.

In operation 350, the input interface 222A of the graphics apparatus 120A receives the graphics commands and/or bitmap from the host-end output interface 214, and then transmits to the image processing circuit 224A.

In operation 360, the image processing circuit 224A of the graphics apparatus 120A generates image frames comprising graphics user interface, computer-generated icons, or texts according to the received graphics commands and/or bitmap. For example, the image processing circuit 224A may generate screen images of “Desktop” of Microsoft's operating system or screen images of a particular application program.

Take the previous situation as an example, when received the graphics command HostBLT and the graphic bitmap of the computer-generated icon, the image processing circuit 224A performs the operation 360 to generate an image frame comprising the computer-generated icon of the shortcut of the application program based on the graphics commands and graphic bitmap. Afterward, when received the graphics command DrawText and the font bitmap of the shortcut name, the image processing circuit 224A adds the name of the shortcut onto the original image frame to form a new image frame comprising the computer-generated icon of the shortcut and the shortcut name based on the graphics command DrawText and font bitmap.

That is, in the computer system 100, image frames comprising graphics user interface, computer-generated icons, or texts are not generated by the processor module 212 of the computer host 110. Instead, they are generated by the image processing circuit 224 of the graphics apparatus 120A. The function of the image processing circuit 224A may be implemented by using a 2D graphics engine or a 3D graphics engine.

In operation 370, the output module 226A of the graphics apparatus 120A transmits the image frames generated by the image processing circuit 224A to the display apparatus 130A coupled with the graphics apparatus 120A. The display apparatus 130A utilizes the receiving module 232A to receive those image frames and then the display module 234A is employed to display the image frames. In operations, the display module 234A displays those image frames on its screen at a predetermined refresh rate so that image flickers is unnoticeable to human eyes. To match up the refresh rate adopted by the display module 234A, the output module 226A of the graphics apparatus 120A transmits the image frames generated by the image processing circuit 224A to the display apparatus 130A at a transmission frequency corresponding to the refresh rate of the display module 234A. For example, in an embodiment where the refresh rate of the display module 234A is 60 Hz, the output module 226A of the graphics apparatus 120A may transmit 60 image frames to the receiving module 232A of the display apparatus 130A per second.

Each of the output module 226A and the receiving module 232A may comprise at least one of Video Graphics Array (VGA) interface (e.g., D-SUB interface), Digital Video Interface (DVI), and High Definition Multimedia (HDMI) interface. The data transmission between the output module 226A and the receiving module 232A may be conducted through a wired cable or wireless transmission manner. In an embodiment where the data transmission between the output module 226A and the receiving module 232A is conducted by using wireless transmission manner, the output module 226A comprises a wireless transmitter for transmitting the image frames generated by the image processing circuit 224A to the receiving module 232A.

In one embodiment, the output module 226A adopts an image output format that is the same as the image input format adopted by the receiving module 232A. In another embodiment, the output module 226A adopts an image output format that is different from the image input format adopted by the receiving module 232A, and an additional image format converting device may be arranged therebetween as a signal transmission intermediate in this case. For example, if the image output interface of the output module 226A is a D-SUB interface, and the image output interface of the receiving module 232A is a DVI interface, then a D-SUB to DVI converter may be employed as a signal transmission intermediate between the output module 226A and the receiving module 232A.

It can be appreciated from the foregoing descriptions that when the computer host 110 wants to display a screen image comprising (or substantively consisted of) GUI data, computer-generated icons, or texts, the processor module 212 of the computer host 110 only needs to convert the rendering requests issued from the operating system into graphics commands, and then transmits the graphics commands to the external graphics apparatus 120A. The processor module 212 needs not to consume computing power to generate image frames. Accordingly, more computing resource of the processor module 212 can be saved, thereby enabling a single computer host 110 to be able to support more graphics apparatuses at the same time.

On the other hand, after the image frames are generated by the image processing circuit 224A of the graphics apparatus 120A based on the graphics commands from the computer host 110, the output module 226A transmits the image frames to the display apparatus 130A at a transmission frequency corresponding to the refresh rate of the display module 234A. However, the host-end output interface 214 of the computer host 110 transmits graphics commands and/or bitmap to the input interface 222A of the graphics apparatus 120A only when the graphics commands are generated by the processor module 212, and needs not to frequently transmit graphics commands to the input interface 222A.

In operations, the frequency of transmitting graphics commands from the computer host 110 to the graphics apparatus 120A via the host-end output interface 214 or data amount transmitted to the graphics apparatus 120A from the computer host 110 is relevant to a user's behaviors, such as typing speed or window switching speed. In general, the user typing speed or window switching speed is far less than the refresh rate of the display module 234A. Accordingly, the frequency of transmitting the graphics commands from the computer host 110 to the graphics apparatus 120A would be much less than the frequency of transmitting the image frames generated by the image processing circuit 224A from the graphics apparatus 120A to the display apparatus 130A, and the former may be even less than 10% of the latter. The computer host 110 may have to transmit many graphics commands to the graphics apparatus 120A via the host-end output interface 214 for a short period when the user just open a text file containing considerable text characters. However, the computer host 110 only needs to transmit the graphics commands and necessary bitmaps, but huge amount of image frames in such case. Thus, the total data amount received by the input interface 222A of the graphics apparatus 120A from the computer host 110 is still much less than the data amount of image frames transmitted from the graphics apparatus 120A to the display apparatus 130A, i.e., the data amount required for refreshing the display apparatus 130A, in the same period.

Therefore, the data transmission amount and data transmission frequency between the host-end output interface 214 and the graphics apparatus 120A would be far less than that of using the conventional USB adapter. As a result, the bandwidth consumption of the host-end output interface 214 can be greatly reduced so that the host-end output interface 214 is able to support more graphics apparatuses under a given bandwidth.

Since most rendering computations are performed by the image processing circuit 224A of the graphics apparatus 120A, the processor module 212 of the computer host 110 needs not to perform the same computations. Accordingly, the workload of the processor module 212 of the computer host 110 can be significantly reduced, thereby increasing the overall operating efficiency of the computer system 100.

The cooperation between the computer host 110 and other graphics apparatuses (e.g., 120B-120F) is similar to the above descriptions for the graphics apparatus 120A, and thus will not be repeated herein for the sake of brevity.

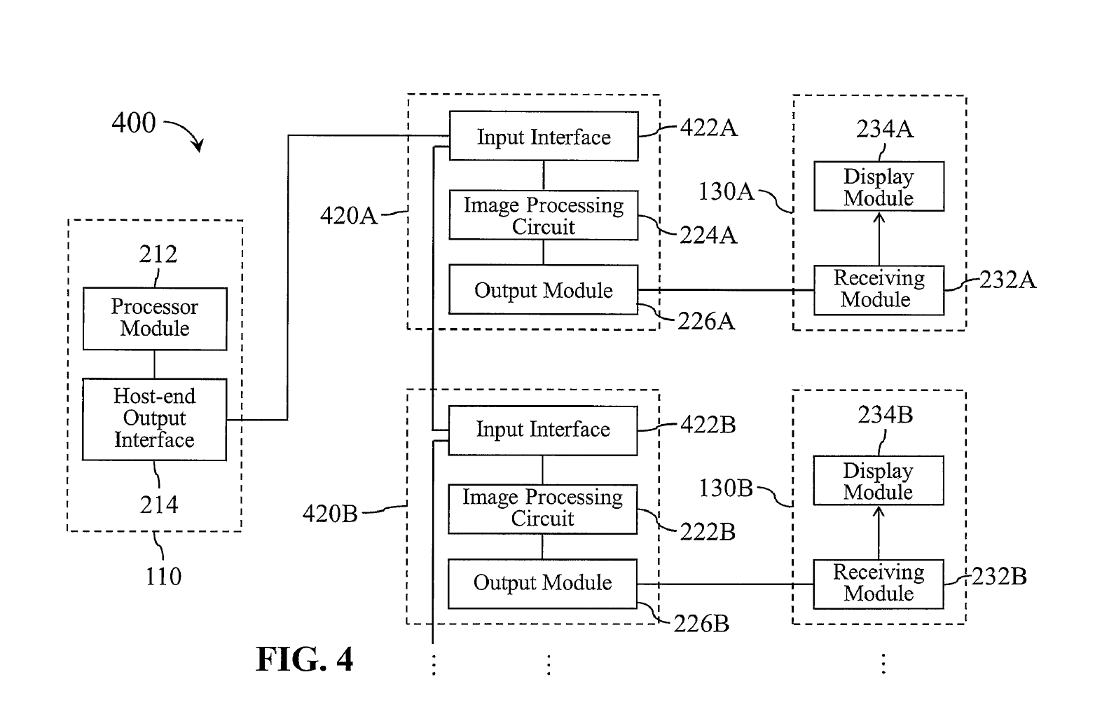

Please refer to FIG. 4, which shows a partial simplified block diagram of a computer system 400 in accordance with another exemplary embodiment. In the computer system 400, the input interface 422A of the graphics apparatus 420A is coupled with the host-end output interface 214 of the computer host 110, the input interface 422B of the graphics apparatus 420B is coupled with the input interface 422A of the graphics apparatus 420A, the input interface of next graphics apparatus (not shown) is coupled with the input interface 422B of the graphics apparatus 420B, and so forth. That is, the multiple graphics apparatuses in the computer system 400 are cascaded, but coupled to the host-end output interface 214 of the computer host 110 in parallel. In an embodiment where the graphics apparatus utilizes a USB interface as an input interface, the input interface also functions as a USB hub. In such architecture, the input interface of each graphics apparatus may have an additional connection port for transmitting the graphics commands (and also corresponding bitmap in certain situations) generated by the computer host 110 to the input interface of another graphics apparatus. This arrangement reduces the number of required connection ports for host-end output interface 214 and thus can further reduce the manufacturing cost of the computer host 110 and increase the flexibility for the connection of the graphics apparatuses. Other components of the computer system 400 operate in the similar way as those of the computer system 100, and thus their operations will not be repeated herein.

In previous embodiment, the computer host 110 is able to support at least six graphics apparatuses. If the processor module 212 of the computer host 110 has greater computing power, or the host-end output interface 214 has more data transmission bandwidth, the disclosed architecture enables a single computer host 110 to be capable of supporting even more than twenty graphics apparatuses at the same time. For an individual user, the usage flexibility of the computer host 110 is greatly improved as the computer host 110 is able to support much more display apparatuses than that in the conventional art.

In addition, when the operating system of the computer host 110 allows multiple users to login in system at the same time, the above architecture enables respective user to utilize respective graphics apparatus, display apparatus, and input interface (such as keyboard and mouse) to couple with the computer host 110 to access the computer host 110 and share its computing resource through. As a result, the resource of a single computer host can be shared by multiple users by using a very compact and low cost architecture. For mobile offices, teaching venues, and many other application environments, the architecture for the disclosed computer system 100 or 400 not only has outstanding value of practical applications, but also reduces the overall hardware cost.

In implementations, the input interface (e.g., 222A or 222B) and image processing circuit (e.g., 224A or 224B) of the graphics apparatus (e.g., 120A or 120B) shown in FIG. 2 may be integrated into the receiving module (232A or 232B) of the display apparatus. In this way, each display apparatus is allowed to be directly coupled to the host-end output interface 214 of the computer host 110.

Alternatively, the input interface (e.g., 422A or 422B) and image processing circuit (e.g., 424A or 424B) of the graphics apparatus (e.g., 420A or 420B) shown in FIG. 4 may be integrated into the receiving module (232A or 232B) of the display apparatus. As a result, when a display apparatus is coupled to the host-end output interface 214 of the computer host 110, other display apparatuses is able to receive the graphics commands from the computer host 110 by cascading to the display apparatus and then perform the image frame generation and displaying operations described previously.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer system comprising:
a computer host comprising:
a processor module; and
a host-end output interface coupled with the processor module for outputting graphics commands generated by the processor module;
at least six display apparatuses; and
at least six graphics apparatuses respectively coupled with the display apparatuses, and each of the graphics apparatuses comprising:
an input interface for receiving corresponding graphics commands when detachably coupled with the host-end output interface;
an image processing circuit coupled with the input interface for generating image frames comprising graphics user interface, computer-generated icons, or texts according to the graphics commands received by the input interface; and
an output module coupled with one of the display apparatuses for transmitting the image frames to a coupled display apparatus for display, wherein the data amount or transmission frequency of image frames transmitted from the output module to the display apparatus is greater than the data amount or transmission frequency of graphics commands transmitted from the host-end output interface to the input interface.

2. The computer system of claim 1, wherein the processor module transmits a first bitmap and a first graphics command to a first graphics apparatus out of the at least six graphics apparatuses through the host-end output interface, and a image processing circuit of the first graphics apparatus generates a first image frame according to the first bitmap and the first graphics command and displays on a first display apparatus out of the at least six display apparatuses;
wherein the processor module transmits a second bitmap and a second graphics command to a second graphics apparatus out of the at least six graphics apparatuses through the host-end output interface, and a image processing circuit of the second graphics apparatus generates a second image frame according to the second bitmap and the second graphics command and displays on a second display apparatus out of the at least six display apparatuses.

3. A graphics apparatus comprising:
an input interface for receiving graphics commands from a computer host when detachably coupled with the computer host;
an image processing circuit coupled with the input interface for generating image frames comprising graphics user interface, computer-generated icons, or texts according to the graphics commands; and
an output module for transmitting the image frames to a display apparatus for display;
wherein the input interface receives the graphics commands from the computer host at a frequency less than a refresh rate of the display apparatus, or the data amount of graphics commands received by the input interface from the computer host is less than the data amount of image frames transmitted to the display apparatus from the output module.

4. The graphics apparatus of claim 3, wherein the input interface comprises a wireless receiver for receiving the graphics commands generated from the computer host through a wireless transmission.

5. The graphics apparatus of claim 3, wherein the output module comprises a wireless transmitter for transmitting the image frames generated by the image processing circuit to the display apparatus through a wireless transmission.

6. The graphics apparatus of claim 3, wherein the input interface is capable of transmitting the graphics commands generated from the computer host to another graphics apparatus coupled with the input interface.

7. The graphics apparatus of claim 3, wherein the input interface comprises at least one of an USB interface, an IEEE 1394 interface, a PC Card interface, a SATA interface, a PATA interface, a PCI interface, a PCI Express interface, an Ethernet interface, and a wireless transmission interface, and the output module comprises at least one of an VGA interface, a DVI interface, and a HDMI interface.

8. The graphics apparatus of claim 3, wherein the graphics commands comprises GDI commands, QuickDraw commands, GDK commands, or Xlib commands.

9. The graphics apparatus of claim 3, wherein the input interface receives the graphics commands from the computer host at a frequency less than one-tenth of the refresh rate of the display apparatus.

10. A display apparatus comprising:
an input interface for receiving graphics commands or bitmaps generated from a computer host when detachably coupled with the computer host;
an image processing circuit coupled with the input interface for generating image frames comprising graphics user interface, computer-generated icons, or texts according to the graphics commands; and
a display module coupled with the image processing circuit for displaying the image frames;
wherein the input interface receives the graphics commands from the computer host at a frequency less than a refresh rate of the display module, or the data amount of graphics commands received by the input interface from the computer host is less than the data amount of image frames transmitted to the display module from the image processing circuit.

11. A computer program product capable of enabling a computer system to perform an image rendering operation, the image rendering operation comprising:
driving a graphics apparatus;
converting a rendering request generated by an operating system of a computer host into graphics commands;
transmitting the graphics commands to the graphics apparatus;
wherein the graphics commands are transmitted to the graphics apparatus at a frequency less than a refresh rate of a display apparatus coupled with the graphics apparatus, or the data amount of graphics commands is less than the data amount required for refreshing the display apparatus.

12. A computer program product capable of enabling a graphics apparatus to perform an image data processing operation, the image data processing operation comprising:
receiving graphics commands generated by a computer host;
generating image frames comprising graphics user interface, computer-generated icons, or texts according to the graphics commands;
transmitting the image frames to a display apparatus;
wherein the graphics commands are received from the computer host at a frequency less than a refresh rate of the display apparatus, or the data amount of graphics commands received from the computer host is less than the data amount of image frames transmitted to the display apparatus.
